(19) United States
(12) Patent Application Publication
(10) Pub. No.: US 2012/0187238 A1
(43) Pub. Date: Jul. 26, 2012

(54) HELICOPTER WITH REMOTE CONTROL

(75) Inventor: ANDREW LAM, CHAI WAN (HK)

(73) Assignee: FUTURE TOYS DESIGN LTD, Chai Wan (HK)

(21) Appl. No.: 13/009,983

(22) Filed: Jan. 20, 2011

(51) Int. Cl. B64C 27/82; B64C 27/10

(52) U.S. Cl. 244/17.21

(57) ABSTRACT

Improvements in a helicopter with a remote control is presented the helicopter has a stacked main rotor to provide vertical lift and control. A plurality of outrigger rotors provides side-to-side stability as well as allowing the body of the helicopter to tip side-to- side. The helicopter further includes an angled tail rotor to provide angular tip to the helicopter as well as providing forward thrust. The remote control is configured as a single stick design. The single stick design allows a user to control the lift of the helicopter with a trigger control for the speed of the main rotor and thumb controlled joystick provides directional movement. The joystick can also provide a charging station for the helicopter where the batteries and the charging cable can be concealed completely within the controller.

### CROSS REFERENCE TO RELATED APPLICATION

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

1. Field of the Invention

This invention relates to improvements in a remote controlled helicopter that is used as a toy or for enjoyment. More particularly, the present application is for a helicopter with multiple rotors and a tail rotor that is mounted at an angle to create forward thrust. A single handed stick controller provides one handed flight control.

2. Description of Related Art including information disclosed under 37 CFR 1.97 and 1.98

Helicopter type child toys that use a single or compound main rotor to create and sustain lift are well known. Early examples come from full scale helicopters. The desire for people to fly scale models require complex programming and mechanics to control the flight path and are especially difficult to control. To increase the flying stability some designs have resorted to compound rotors for flight stability and lift. These units are generally able to move vertically without trouble and can spin, but they have limited ability for horizontal flight. Typically these toy helicopters rely on the tail rotor to rotate the body of the helicopter and the main rotor(s) for thrust.

The main rotor(s) typically rotate in a vertical plane. Environmental factors such as wind or power fluctuations may cause the main rotor blades to bend or pitch thereby causing the aircraft to tip, turn, oscillate or bank. This effect may be compensated for and corrected in various ways with complicated programming and mechanics. The ability to maintain horizontal stability with this type of rotor design is difficult especially with an inexperienced user. The design construction and fabrication of simple toy type helicopters is difficult without resorting to expensive gyros, servos and sensors.

Several products and patents have been filed and issued on helicopter designs. Exemplary examples of patents covering these products are disclosed herein.

U.S. Pat. No. 7,815,482 issued on Oct. 19, 2010 to Alexander Van De Rostyne and a series of other related applications from the same inventor disclose a helicopter with a primary and a secondary main rotor and a horizontally mounted tail rotor. While this patent discloses a helicopter it does not include a remote control that is operated with a single hand. In addition the helicopter does not have a tail rotor that provides forward thrust or a plurality of outrigger thrusters to provide side to side stability.

U.S. publication number 2006/0231677 published on Oct. 19, 2006 to Nachman Zimet et al discloses a Rotary-Wing Vehicle System and Methods Patent using stacked main rotors and a pair of rear facing pusher rotors. The remote control in this patent requires two handed operation for thrust and travel direction. The helicopter does not have an angled tail rotor to provide horizontal thrust or outrigger thrusters to provide side to side stabilization.

U.S. publication number 2010/0124865 published on May 20, 2010 to Alexander jozef Magdelena Van De Rostyne et al discloses a flying toy with two separate main rotors. The flying toy in this application uses a pair of vertical rotors where the angle of the rotors is adjustable for directional movement. A remote control that allows for single handed control is not included in this publication and both rotors are integrated into the wing of the toy.

publication 2009/0170395 published on Jul. 2, 2009 to Chi Pok Wai discloses an integrated remote control and storage housing where the helicopter can be stored within the remote control housing. The remote control storage housing requires two handed operation to control the lift and direction of travel of the helicopter. Further the helicopter has a stacked main rotor and a horizontal tail rotor. The publication does not disclose a helicopter with a tail rotor that provides forward thrust.

What is needed is a helicopter with stacked main rotors, a tail rotor that provides thrust and a plurality of outrigger thrusters. In addition the helicopter should also include a remote control configured as a stick to allow for single handed control of the helicopter as disclosed in this application.

### BRIEF SUMMARY OF THE INVENTION

It is an object of the helicopter with a remote control for the helicopter to have stacked main rotor to provide vertical lift and control. The stacked counter rotating main rotors eliminates the requirement for a horizontally mounted tail rotor because the rotational effects of the main rotor is canceled by using multiple counter rotating main rotors.

It is another object of the helicopter with a remote control for the helicopter to have a plurality of outrigger rotors to provide side-to-side stability as well as allowing the body of the helicopter to tip side-to-side. In most stacked main rotor designs side to side stability is provided by altering the attack angle of the main rotor blades or the relative rotation rate of the two main rotors. The use of outrigger thrusters provides the benefit of additional lift and correct for side-to-side rotation of the helicopter. The ability to tip the helicopter allows for tighter turning of the helicopter because the lift from the main rotors can be directed at an angle offset from vertical to push the body of the helicopter in the tipped direction.

It is another object of the helicopter with a remote control for the helicopter to have an angled tail rotor to provide angular tip to the helicopter as well as providing forward thrust. The normal balance of the helicopter places the rotational axis of the main rotor in a vertical orientation. Changing the rotational speed of the tail rotor allows the front-to-back body angle of the helicopter to be altered. The tail rotor is placed in-line with the main rotors and can lift the back of the helicopter to use the main rotor to push the helicopter forward.

It is still another object of the helicopter with a remote control for the remote control to be configured as a single stick design. In an actual helicopter the direction or travel is controlled with a single control stick and a pair of floor pedals. The single stick design allows a user to control the lift of the helicopter with a trigger control for the speed of the main rotor and thumb controlled joystick provides directional movement. In addition, a pair of thumb accessible trim buttons adjusts the helicopter for vertical lift when the joystick is in a neutral position. The joystick can also provide a charging station for the helicopter where the batteries and the charging cable can be concealed completely within the controller.

Various objects, features, aspects, and advantages of the present invention will become more apparent from the following detailed description of preferred embodiments of the invention, along with the accompanying drawings in which like numerals represent like components.

### BRIEF DESCRIPTION OF THE SEVERAL VIEWS OF THE DRAWING(S)

FIG. 1A shows a perspective view of a helicopter.

FIG. 1B shows a single hand operable remote control.

FIG. 2 shows a perspective view of the helicopter in the preferred embodiment.

FIG. 3 shows a side view of the helicopter.

FIG. 4 shows a rear perspective view of the helicopter.

FIG. 5 shows a detail view of the tail rotor.

FIG. 6 shows a first detail view of an outrigger rotor.

FIG. 7 shows a second detail view of an outrigger rotor.

FIG. 8 shows top perspective view of both outrigger rotors.

FIG. 9 shows a side view of the remote control.

FIG. 10 shows a front view of the remote control.

### DETAILED DESCRIPTION OF THE INVENTION

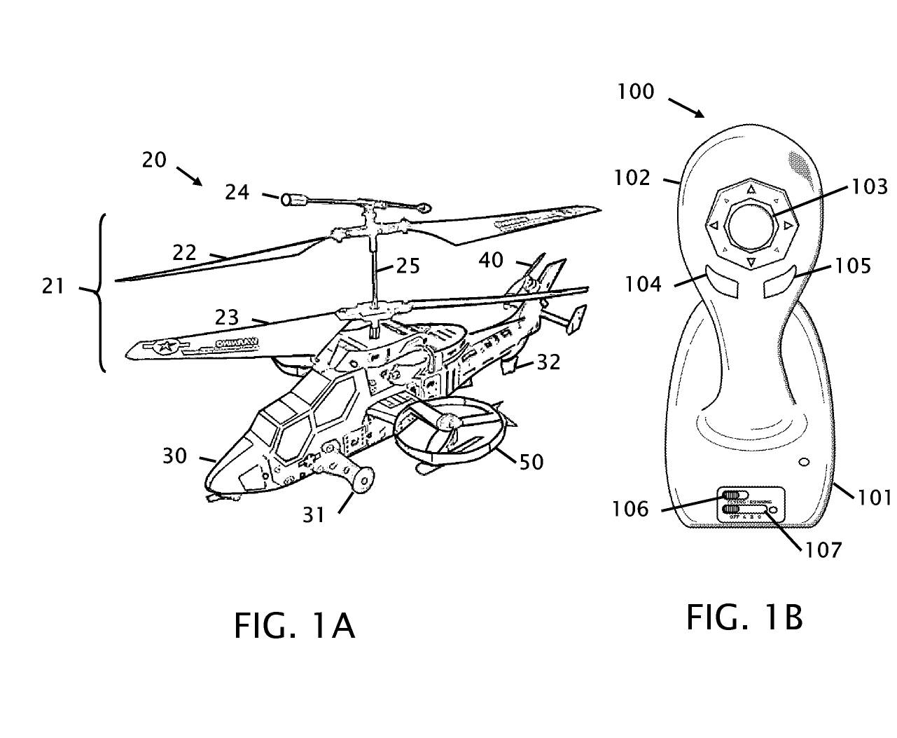

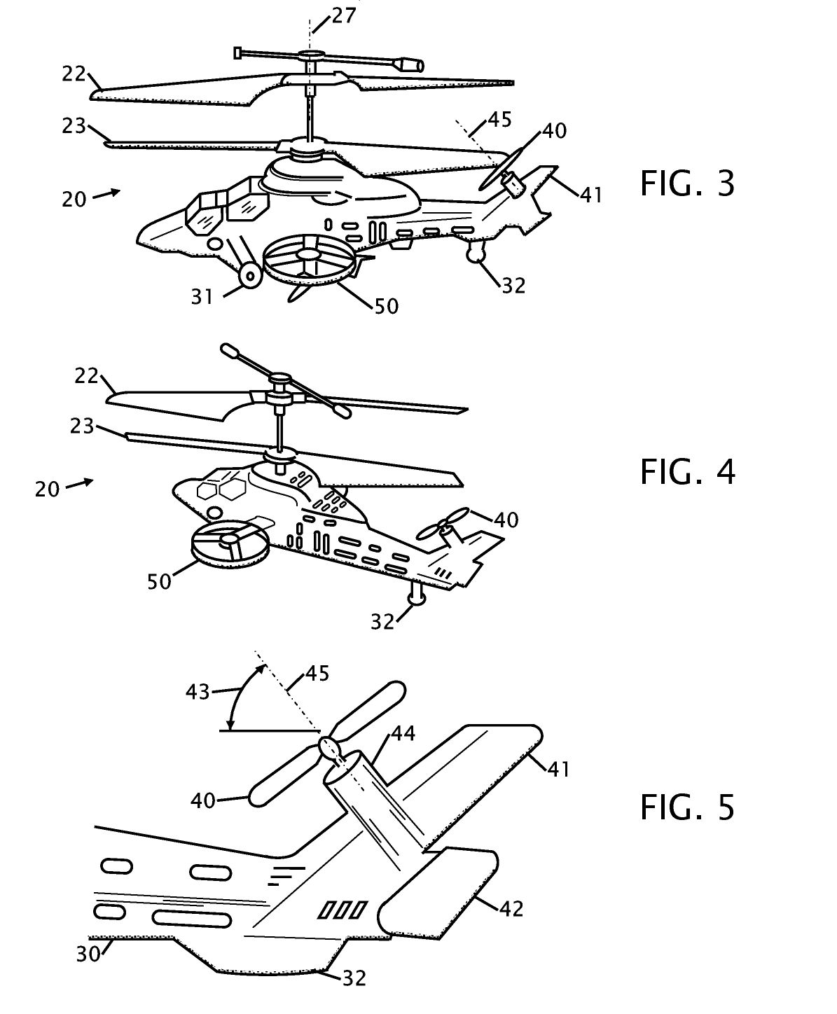

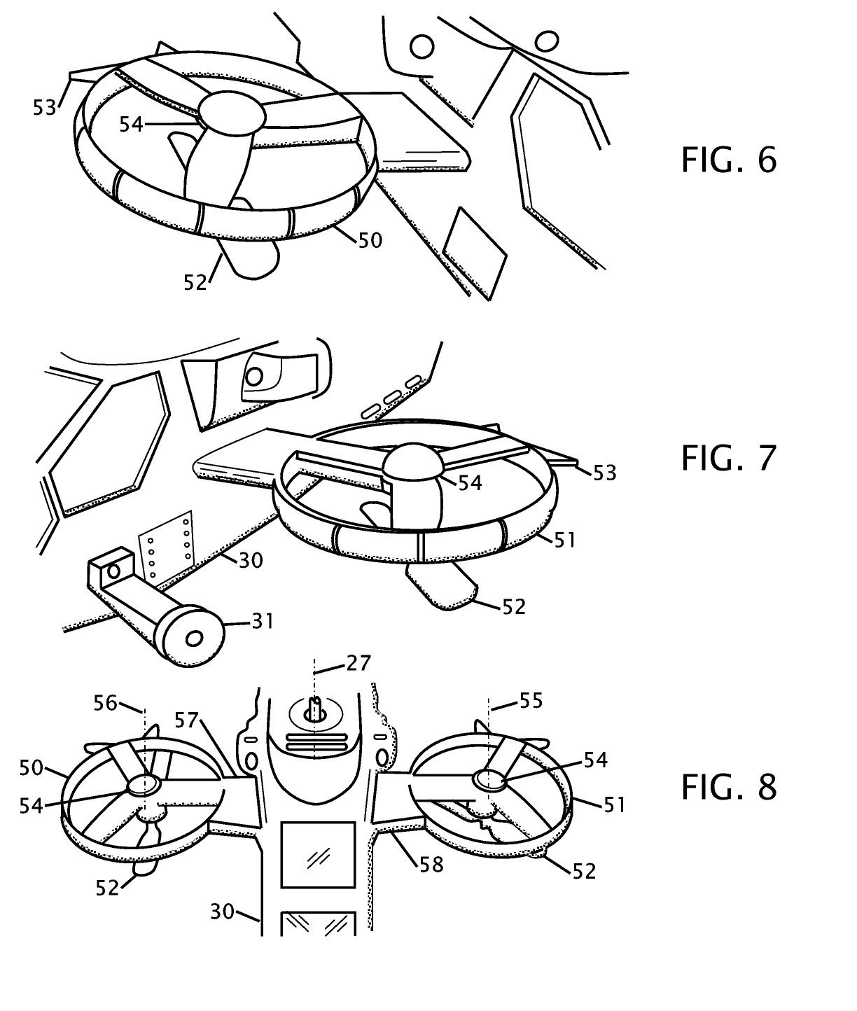

FIG. 1A shows a perspective view of a helicopter 20. In this embodiment the body 30 of the helicopter is shaped as an apache style helicopter but other body styles having a single or double main rotor are contemplated. The body 30 has a pair of front landing wheels 31 that extend from the central body to provide support of the body then the helicopter is not in flight. In addition to the front landing gear 31 a rear skid 32 or landing gear is located in the back of the helicopter to provide a three point landing structure. The helicopter has a main rotor 21 that includes two counter rotating main blades that provide lift for the body 30 of the helicopter 20. The main blades 21 include a bottom blade 23 a top blade 22 and a counter weight 24. The blades rotate in opposing directions to reduce or eliminate gyroscopic spin thereby requiring a tail rotor that is oriented to counteract the twisting forces from a single rotor blade. An outer shaft 26 is connected to the bottom blade 23 and an inner shaft 25 is connected to the top blade 22 thereby allowing the blades to turn in opposite directions. This preferred embodiment also includes a tail rotor 40 that is mounted in the same rotational plane as the main rotor 21. The tail rotor is shown and described in more detail with FIGS. 3 to 5. A plurality of outrigger rotors 50 and 51 are mounted on the sides of the main body 30. The outrigger rotors 50 and 51 are shown and described in more detail in FIGS. 6 to 8.

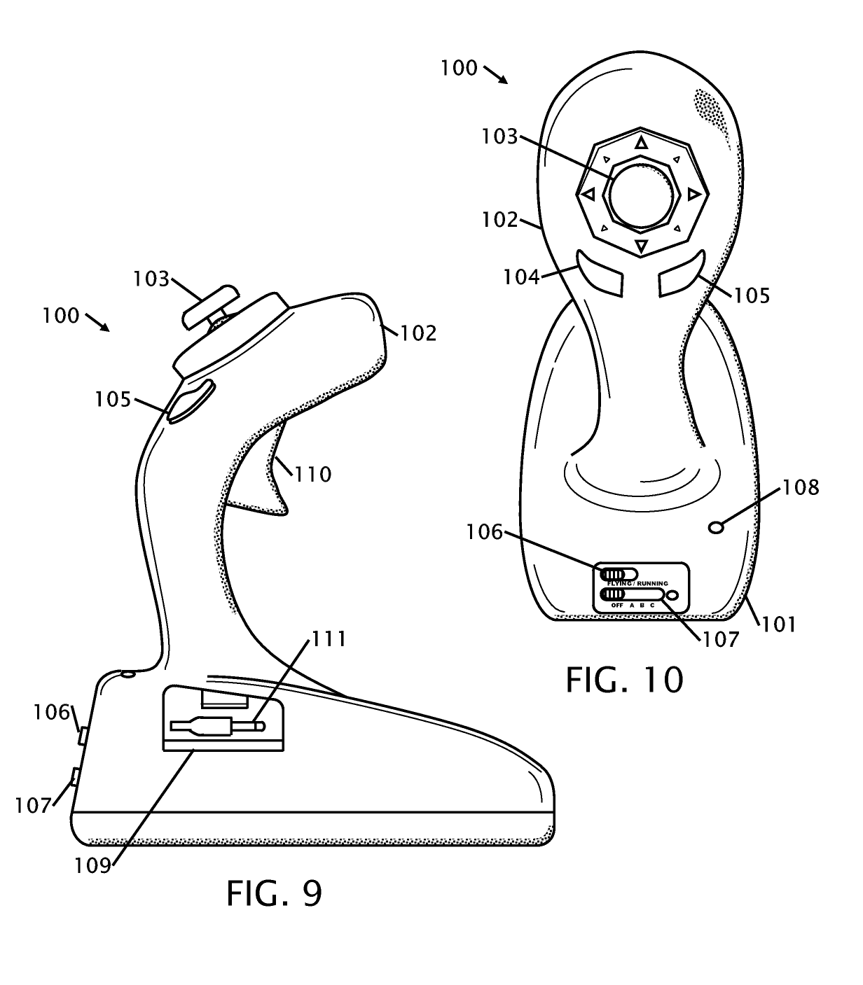

FIG. 1B shows a single hand operable remote control 100. The single hand operable remote control 100 can be operated by resting the base 101 of the remote control 100 on a flat surface or can be operated by holding the stick 102 in the air with a single hand. From this view the flight direction joystick 103 is visible. The flight direction joystick is controllable using the thumb of the operator. Trim buttons 104 and 105 allow an operator to “trim” out undesirable flight anomalies. The lower front of the remote includes switches for flying/running mode 106 and power flight modes 107. The remote control 100 is shown and described in more detail with FIGS. 9 and 10.

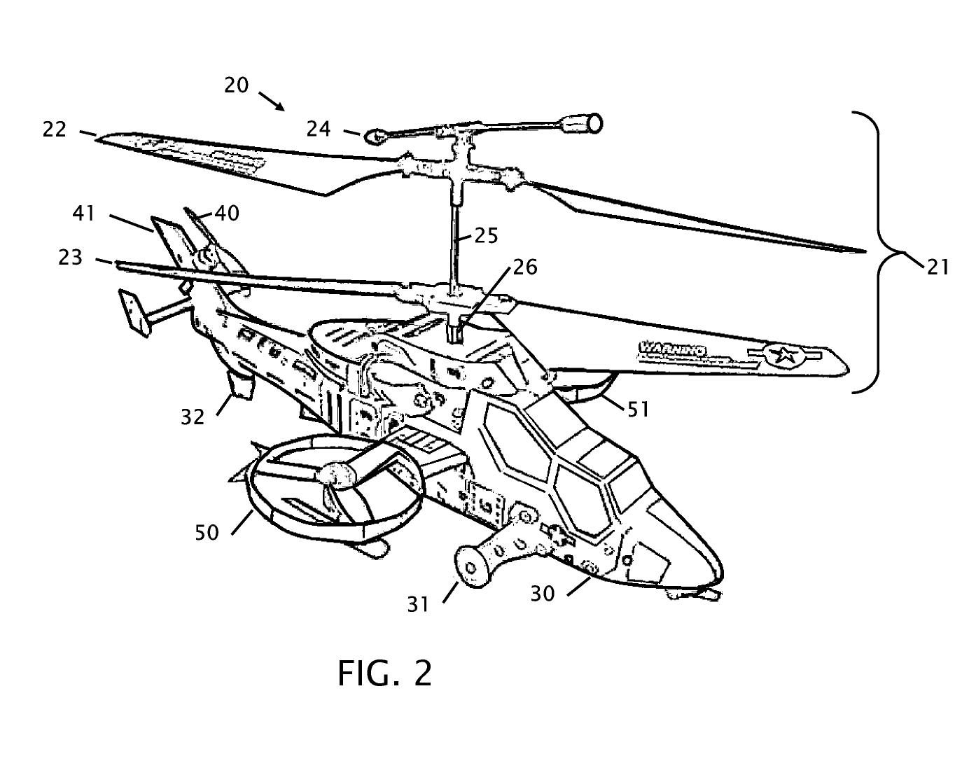

FIG. 2 shows a perspective view of the helicopter in the preferred embodiment. The body 30 shows a pair of front landing wheels 31 extending from the central body 30to provide a wider support stance to support the body 30 for storage, take-off and landing. A rear skid 32 or landing gear is located in the back of the helicopter to provide a three point landing structure. The helicopter has a main rotor 21 that includes two counter rotating main blades that provide lift for the body 30 of the helicopter 20. The main blades 21 include a bottom blade 23 a top blade 22 and a counter weight 24. An outer shaft 26 is connected to the bottom blade 23 and passes around an inner shaft 25 that is connected to the top blade 22 thereby allowing the blades to turn in opposite directions. A plurality of outrigger rotors 50 and 51 are mounted on the sides of the main body 30. A vertical tail fin 41 provides structure for a tail rotor 40 that is mounted in the same rotational plane as the main rotor 21 and is shown and described in more detail with FIGS. 3 to 5.

FIG. 3 shows sides view of the helicopter 20 FIG. 4 shows a rear perspective view of the helicopter 20 and FIG. 5 shows a detail view of the tail rotor. The landing gear 31 and 32 is visible in some of these figures as it supports the body 30 of the helicopter. Because dual counter rotating rotors 22 and 23 are used, an orthogonally mounted tail rotor is not required. A vertical tail fin 41 and supplemental vertical fins 42 provide a similar appearance to the apache helicopter. In this embodiment the tail rotor 40 is mounted within the vertical tail fin 41 and rotates 27 in the same plane as the rotational axis 27 main rotor(s) 22 and 23. The tail rotor 40 is connected to a motor 44. Orienting the tail rotor in this orientation allows the tail rotor 40 to provide forward thrust to the helicopter and also allows the horizontal angle of the body to be altered to allow the downwash from the main rotors 22 and 23 to push the helicopter forward. The angle 43 of the tail rotor is preferably in a range of 30 to 60 degrees from horizontal. In the angle is too shallow then the tail rotor simply pushes the helicopter 20 forward. In the angle is too steep then the tail rotor only pushes the back of the helicopter down and does not provide any forward propulsion. The tail rotor provides front-to-back rotation of the helicopter body 30. Outrigger rotors 50 are shown in some of these figures.

FIG. 6 shows a first detail view of an outrigger rotor 50, FIG. 7 shows a second detail view of an outrigger rotor 51 and FIG. 8 shows top perspective view of both outrigger rotors 50 and 51 extending from the main body 30 of the helicopter with extension arms 57 and 58. The outrigger rotor 50 and 51 each have their own separate motor 54 and propeller 52 thereby enabling each outrigger to be independently controlled to push or pull either side of the body or the helicopter to create side-to-side stability and movement to the helicopter. Both of these outrigger rotors are located below both main rotors and rotate in essentially the same rotational plane axis 55 and 56 as the main rotor 27. Each outrigger rotor 50 and 51 is located on the outside of the mail body 30 and outside of the landing gear 31. The outrigger rotors have air directing housing and fins 53 to adjust air flow over and through the outrigger rotors 50 and 51. The outrigger rotors can alter the vertical orientation of the helicopter to allow the main rotor to push the helicopter left or right and the airflow direction from the main rotor is moved off of vertical.

FIG. 9 shows a side view of the remote control and FIG. 10 shows a front view of the remote control. In the preferred embodiment the remote control 100 communicates and commands the helicopter 20 with an inferred communication but other modes of communication are contemplated including but not limited to RF and Bluetooth. The single hand operable remote control 100 can be operated by resting the base 101 of the remote control 100 on a flat surface or can be operated by holding the stick 102 in the air with a single hand. From these view the flight direction joystick 103 is visible and shows that the joystick 103 can control the flight of the helicopter to move the helicopter forward, backward, left, right and diagonal directions. Trim buttons 104 and 105 allow an operator to “trim” out undesirable flight anomalies that would require user correction to achieve straight line flight. The single control stick 100 allows a user to operate the helicopter using a single joystick as might be found and used in a real helicopter.

The lower front of the remote includes switches for flying / running mode 106 and power flight modes 107. The remote control includes a charging port or connector 111 that plugs into a charging port on the helicopter to charge the helicopter. A charge light 108 is visible in FIG. 10 that indicates the charging status of the helicopter. The charging port is located under a hinged cover 109 to provide storage of the port. Batteries are located under the joystick to provide both power to the control stick 100 and provide battery charging to the helicopter 20. A front trigger 110 controls the speed of the main rotors of the helicopter. The speed is variable based upon the amount of pressure or displacement that is applied to the trigger 110.

Thus, specific embodiments of a helicopter with a remote control have been disclosed. It should be apparent, however, to those skilled in the art that many more modifications besides those described are possible without departing from the inventive concepts herein. The inventive subject matter, therefore, is not to be restricted except in the spirit of the appended claims.

1. A helicopter with a remote control comprising:
a helicopter body having a motor connected to a main propeller rotor that extends essentially vertical through said helicopter body;
said main propeller comprises at least two counter rotating blades that create lift for said helicopter body;
a tail rotor having a rotational axis that is tipped from a vertical axis towards said main propeller rotor to provide forward thrust and front-to-back tip to said helicopter body, and
a remote control that controls a flight of said helicopter body.

2. The helicopter with a remote control according to claim 1 wherein said tail rotor is tipped between 30 and 60 degrees from said vertical axis.

3. The helicopter with a remote control according to claim 1 that further includes at least two independent outrigger rotors located below said main propeller that rotate in an axis that is essentially parallel to said main propeller.

4. The helicopter with a remote control according to claim 3 wherein said at least two independent outriggers provide side-to-side rotation and stability to said helicopter body.

5. The helicopter with a remote control according to claim 3 wherein said at least two independent outrigger rotors and said main rotor rotate in essentially the same vertical plane.

6. The helicopter with a remote control according to claim 1 wherein said remote control is configured to provide one handed control of lift and direction of travel of said helicopter body.

7. The helicopter with a remote control according to claim 6 wherein said lift is controlled with a finger and said direction is controlled with a thumb controllable joystick.

8. A helicopter with a remote control comprising:
a helicopter body having a motor connected to a main propeller rotor that extends essentially vertical through said helicopter body;
said main propeller comprises at least two counter rotating blades that create lift for said helicopter body;
at least two independent outrigger rotors that rotate in an axis that is essentially parallel to said main propeller and are located on the outer sides of said helicopter body, and
a remote control that controls a flight of said helicopter body.

9. The helicopter with a remote control according to claim 8 that further includes a tail rotor.

10. The helicopter with a remote control according to claim 9 wherein said tail rotor has a rotational axis that is tipped from a vertical axis towards said main propeller.

11. The helicopter with a remote control according to claim 10 wherein said tail rotor is tipped between 30 and 60 degrees from said vertical axis.

12. The helicopter with a remote control according to claim 8 wherein said at least two independent outriggers provide side-to-side rotation and stability to said helicopter body.

13. The helicopter with a remote control according to claim 8 wherein said at least two independent outrigger rotors and said main rotor rotate in essentially the same vertical plane.

14. The helicopter with a remote control according to claim 8 wherein said remote control is configured to provide one handed control of lift and direction of travel of said helicopter body.

15. The helicopter with a remote control according to claim 14 wherein said lift is controlled with a finger and said direction is controlled with a thumb controllable joystick.

16. A helicopter with a remote control comprising:
a helicopter body having a motor connected to a main propeller rotor that extends essentially vertical through said helicopter body;
a tail rotor;
a remote control that controls a flight of said helicopter body that is configured to provide one handed control of lift and direction of travel of said helicopter body, wherein lift is controlled with a finger and said direction is controlled with a thumb controllable joystick.

17. The helicopter with a remote control according to claim 16 wherein said tail rotor has a rotational axis that is tipped from a vertical axis towards said main propeller between 30 and 60 degrees from said vertical axis.

18. The helicopter with a remote control according to claim 16 that further includes at least two independent outrigger rotors located below said main propeller that rotate in an axis that is essentially parallel to said main propeller.

19. The helicopter with a remote control according to claim 18 wherein said at least two independent outriggers provide side-to-side rotation and stability to said helicopter body and said at least two independent outrigger rotors and said main rotor rotate in essentially the same vertical plane.

20. The helicopter with a remote control according to claim 16 wherein said main propeller comprises at least two counter rotating blades that create lift for said helicopter body.
